(19) United States
(12) Patent Application Publication
(10) Pub. No.: US 2010/0316832 A1
(43) Pub. Date: Dec. 16, 2010

(54) FLOCKED ARTICLE HAVING A WOVEN INSERT AND METHOD FOR MAKING THE SAME

(75) Inventor: Louis Brown ABRAMS, Fort Collins, CO (US)

Correspondence Address: SHERIDAN ROSS PC, 1560 BROADWAY, SUITE 1200, DENVER, CO, 80202, US

(73) Assignee: HIGH VOLTAGE GRAPHICS, INC., Fort Collins, CO (US)

(21) Appl. No.: 12/758,633

(22) Filed: Apr. 12, 2010

Related U.S. Application Data
(60) Provisional application No. 61/168,483, filed on Apr. 10, 2009.

(51) Int. Cl. B32B 33/00; B32B 38/00; B32B 37/12

(52) U.S. Cl. 428/90; 156/250; 156/297

(57) ABSTRACT

The present invention relates generally to a process for making a decorative article, more specifically to a method of making a decorative article containing flock and an insert, such as a woven insert.

### CROSS REFERENCE TO RELATED APPLICATIONS

The present application claims the benefit of U.S. Provisional Application Ser. No. 61/168,483, filed Apr. 10, 2009, entitled “Flocked Articles Having a Woven Insert and Methods for Making the Same,” which is incorporated herein by this reference in its entirety.

Cross-reference is made to U.S. patent application Ser. Nos. 12/031,455 filed Feb. 14, 2008, entitled “Sublimation Dye Printed Textile”, 12/580,120 filed Oct. 15, 2009, entitled “Multi-Colored Two-Part Flocked Transfer and Method of Making and Process of Using the Same”, and 12/706,622, filed Feb. 16, 2010, entitled “Flocked Stretchable Design or Transfer Including Thermoplastic and Method for Making and Using the Same”, each of which is incorporated herein in their entirety by this reference.

### FIELD OF INVENTION

The present invention relates generally to a process for making a decorative article, more specifically to a method of making a decorative article containing flock and an insert, such as a woven insert.

### BACKGROUND OF THE INVENTION

Decorative textile articles are used in a wide variety of applications. For example, textile decorative articles having flock are used as patches, transfers, molded objects, and the like. Generally, flocked decorative articles are less expensive than embroidered articles to manufacture and the flock provides a “plusher” feel to the article relative to embroidered articles. Flocked decorative articles having inserts are gaining in popularity.

Decorative textile articles having flock fibers and an insert, such as a woven insert are being more complex and detailed. As such, the traditional method for making such decorative textile articles typically cannot provide the level of detail and/or fail to product articles meeting greater performance characteristics.

### SUMMARY OF THE INVENTION

These and other needs are addressed by the various embodiments and configurations of the present invention. This disclosure relates generally to a process from making a decorative article, the decorative article having one or both of flock and an insert, such as, but not limited to a decorative article containing a woven insert.

One aspect of the present invention is a process for making a flocked appliqué. In one embodiment, the process comprises contacting a flock transfer with a first adhesive, after the first adhesive has been contacted an insert. In another embodiment, the process comprises contacting the first adhesive with the flock transfer before the first adhesive is contacted with the insert.

Preferably, the insert has one or more insert registration indexes. The insert has opposing first and second insert sides. The first adhesive is in contact with and/or positioned on the first insert side and a second adhesive is in contact with and/or positioned on the second insert side.

In a preferred embodiment, the flock transfer has one or more flock transfer registration indexes. The flock transfer has a plurality of flock fibers having opposing first and second flock fiber ends. The first flock fiber ends are in contact with the first adhesive. The flock transfer is adhered to the insert by the first adhesive. The first flock fiber ends are adhered to the insert by the first adhesive. The second flock fiber ends are adhered to a carrier sheet by a release adhesive. The release adhesive is positioned between the carrier sheet and the plurality of flock fibers.

Preferably, the insert comprises a woven textile. The woven textile is provided with or without an image. The image is one or both of a dye printed image and an image woven into the weave of the woven textile. Preferably, the woven textile has flat, smooth weave. More preferably, the woven textile weave is a weave comprising a high luster yarn and/or fiber.

In one embodiment, the woven textile is one of a satin weave having an interlacing float of at least 2, a brocade weave, a brocatelle weave, a camocas weave, a crepe weave, a duchesse weave, a double-face satin weave, a paillette satin weave, a peaue de soie weave, a satin-back weave, a satin foaconne weave, a slipper satin weave, a velvet satin weave, and a non-satin weave, having a degree of dimensionality and/or character.

In another embodiment, the woven textile is selected from the group consisting essentially of: jacquard, brocade, bedford, damask, wandering weft, leno, needle lace, bobbin lace, embroidered netting, looped netting, knotted netting, open-work embroidery, knitting, macramé, sprang, wrap-faced, weft-faced, brocatelle, slit tapestry, dovetailed tapestry, interlocking tapestry, eccentric tapestry weaves, and combination weaves thereof.

The graphic design image of the woven textile includes one or more of a printed graphic design image, an image woven into the woven textile weave, and a combination thereof. The graphic design element is formed by weaving yarns and/or printing an image on a woven textile. The woven textile includes yarns having substantially the same and/or yarns having substantially differing colors.

In yet another embodiment, a three-dimensional character is embossed into the insert as described in U.S. patent application Ser. Nos. 11/874,146 filed Oct. 17, 2007, and 12/031,445 filed Feb. 14, 2008, each of which is incorporated in its entirety by this reference. It can be appreciated that the embossing process discussed in the above referenced U.S. Patent Applications is applicable to a variety of inserts, including without limitation, woven textiles laminates (that is, the woven textile laminated to the second adhesive), polymeric films and/or sheets, metal foils and/or sheets, or any other formable material.

In a preferred embodiment, the flock transfer is contacted and positioned on the insert relative to the one or both of the one or more woven textile indexes and the one or more flock transfer registration indexes. In a more preferred embodiment, one of before, after and/or during the contacting one or both of heat and pressure are applied to at least one of the flock transfer and insert. One or both of the heat and pressure adheres the flock transfer to the insert.

Preferably, the first adhesive is one of a thermoplastic adhesive, a thermosetting adhesive and a combination of thermosetting and/or thermoplastic adhesives. Furthermore, the second adhesive is, preferably, one of a thermoplastic adhesive, a thermosetting adhesive and a combination of thermosetting and/or thermoplastic adhesives. The first and second adhesives can have the same composition or can have differing compositions.

In one embodiment, the second adhesive is an adhesive laminate having two or more adhesive layers. When the second adhesive has more than two layers, at least one of the more than two layers can be a composition other than an adhesive composition, such as, but not limited to an elastomeric material. The adhesive layers can have the same composition or can have differing compositions.

In a preferred embodiment, one or both of the first and second adhesives are substantially free of one or more of formaldehyde, epichlorohydrin and volatile organic compounds. In another embodiment, one or both of the first and second adhesives have at least one elastomeric property.

In a preferred embodiment, the first adhesive is contacted and positioned on the insert relative to the one or more insert registration indexes. Preferably, the first adhesive is contacted with the insert in a printing process. More preferably, the first adhesive is contacted with the insert in a screen-printing process.

In a preferred embodiment, the process further includes cutting the flocked assembly to form a flocked appliqué. The cutting is preferably by one of a die, a laser, a hot wire, and/or an electric arc, more preferably by one of a laser, hot wire or electric arc.

As used herein, directly adhering of the flock fibers to the insert by the first adhesive means one or more of the following: a) the flock fiber ends contacting the first adhesive lack an adhesive prior to contacting the first adhesive; b) the flock fiber ends contacting the first adhesive are free of an intermediate adhesive between the flock fibers ends contacting the first adhesive and the first adhesive; and c) the flock fiber ends contacting the first adhesive are devoid of an adhesive prior to contacting the first adhesive.

These and other advantages will be apparent from the disclosure of the invention(s) contained herein.

As used herein, the term “a” or an entity refers to one or more of that entity. As such, the terms “a” (or “an”), one or more and at least one can be used interchangeably herein. It is also to be noted that the terms “comprising”, “including”, and “having” can be used interchangeably.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present invention(s). These drawings, together with the description, explain the principles of the inventions(s). The drawings simply illustrate preferred and alternative examples of how the invention(s) can be made and used and are not to be construed as limiting the invention(s) to only the illustrated and described examples.

Further features and advantages will become apparent from the following, more detailed, description of the various embodiments of the invention(s), as illustrated by the drawings referenced below.

FIG. 1 depicts a process according to one or more embodiments of the present invention;

FIG. 2 depicts a flocked assembly made according to the one or more embodiments depicted in FIG. 1;

FIG. 3 depicts a flocked appliqué made according to the one or more embodiments depicted in FIG. 1;

FIG. 4 depicts a flock transfer carrier sheet having one or more registration indexes; and

FIG. 5 depicts an insert having one or more insert registration indexes.

### DETAILED DESCRIPTION OF THE INVENTION

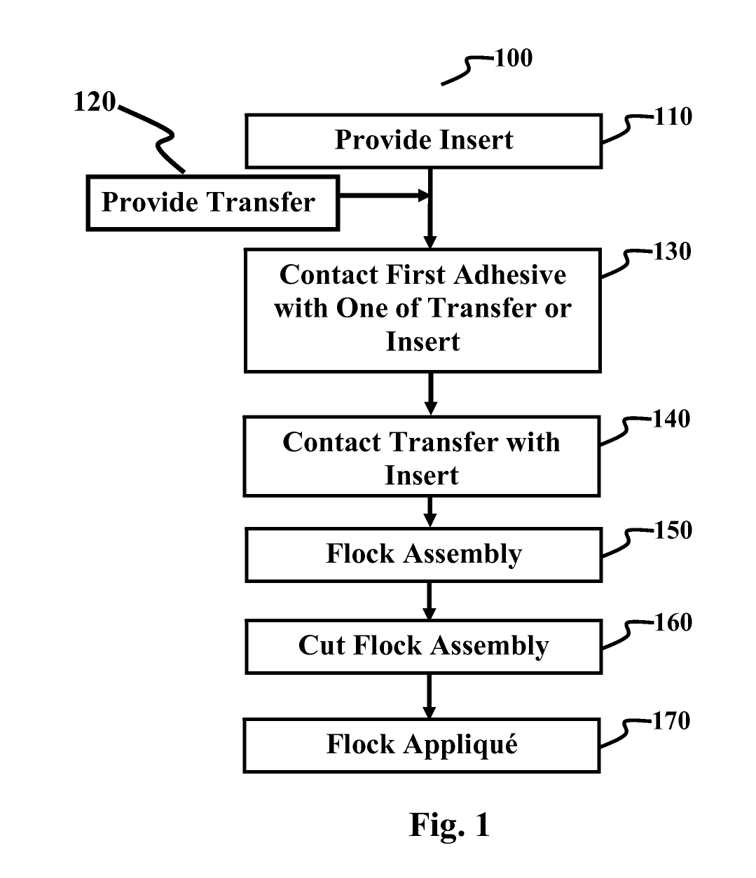

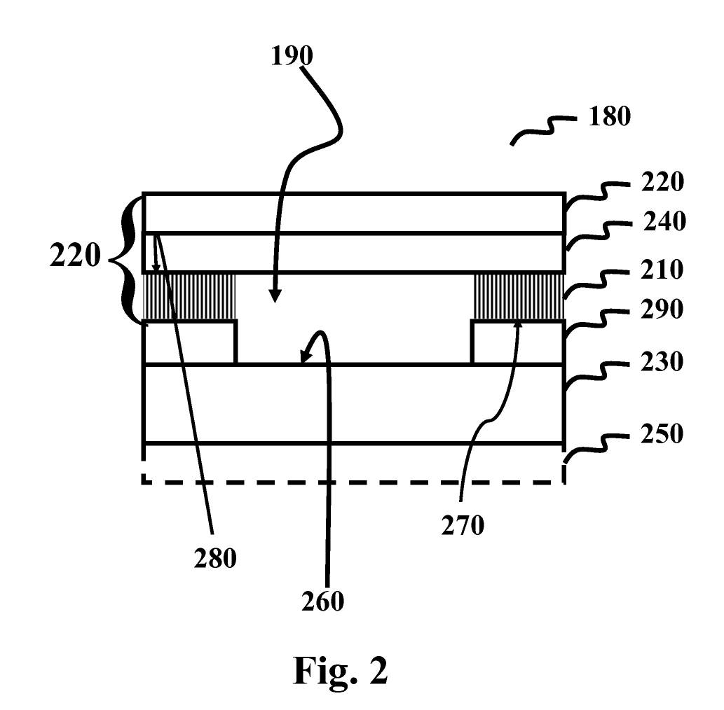

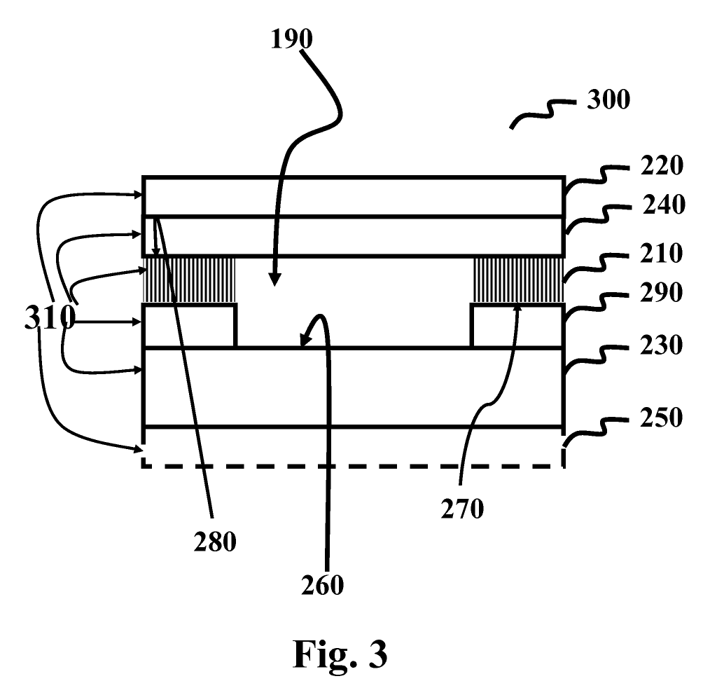

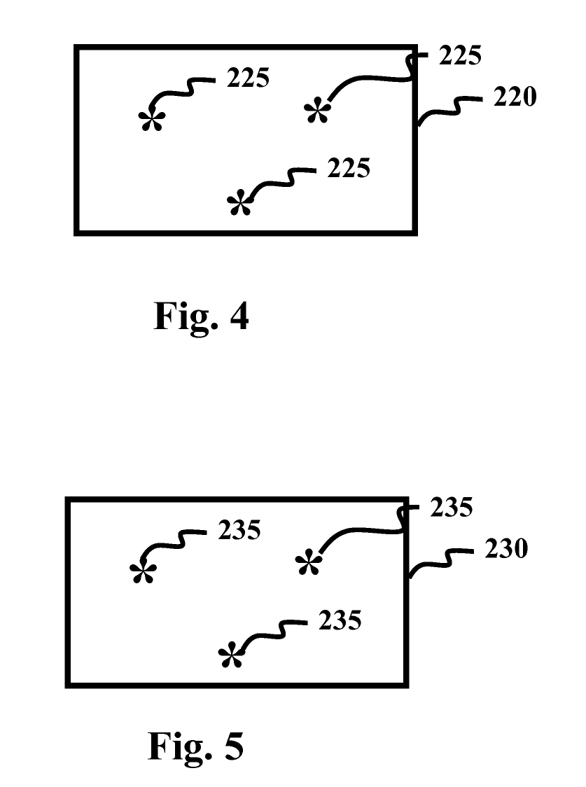

FIG. 1 depicts a process 100 according to one embodiment of the present invention. In step 110, an insert 230 is provided. The insert 230 can be any material. Non-limiting examples of the insert 230 are a woven textile, a polymeric material (such as a polymeric sheet and/or film), a metallic material (such as a metallic sheet or film), a naturally occurring material (such as leather, mineral and/or cellulosic materials) and combinations and/or mixtures thereof.

The insert 235 has opposing first and second insert sides. Preferably, the insert has one or more insert registration indexes 235. The one or more insert registration indexes 235 can be on one or both of the first and second insert sides. Preferably, the insert registration indexes are one of the first and second insert sides. The insert registration indexes 235 can be at least one of optical and/or mechanical insert registration indexes. Non-limiting examples of insert registration indexes 235 are notches, apertures, optically identifiable symbols, and insert identifiable profile characteristics (such as, a physical characteristic of the insert, e.g. height, depth, an edge, etc.).

In a preferred embodiment, the insert 230 comprises a woven textile. Examples of suitable woven textiles are disclosed in U.S. patent application Ser. Nos. 12/031,445 filed Feb. 14, 2008 and 12/397,946 filed Mar. 4, 2009, all to Abrams, each of which are incorporated herein by this reference in its entirety.

In a preferred embodiment, the woven textile material has a weave. Exemplary woven textiles include loosely or heavily woven polyesters with increased surface dimensionality or character. The woven textile is preferably formed from polyester fibers or yarn and more preferably is composed of shiny polyester “floss” yarns.

In a preferred embodiment, the woven textile has an image. The image can be dyed printed image, such as a sublimation dye-printed image, and/or an image woven into the woven textile weave. In some embodiments, the woven textile lacks an image. That is, the woven textile can be free of one or both of a dye-printed image and an image woven into the weave of the woven textile.

In one configuration, the preferred weave is a heavy-weave or one or more of a highly textured (or raised pattern), dimensionalized, loose (or open), and high loft. Such weaves are typically lustrous, due to their increased reflectivity. Preferably, the woven textile is loosely woven polyester with increased surface dimensionality or character.

In one configuration, one or both of weave dimensionality and character are introduced to the weave by one or more of the following methods: 1) weaving the textile more loosely; 2) “crowding” the yarn during the weaving process; 3) “exaggerating” the weave; 4) weaving in an irregular pattern; 5) weaving or introducing after weaving a high dimensional profile; and 6) introducing surface “loops.”

In one configuration, the woven textile comprises a high luster yarn (or fiber) in a flat, smoothly woven type weave, such as, but not limited to satin type weaves with an interlacing float of at least 2 or to at least the following satin weave types commonly known within the art as:
a) Brocade—A brocade weave is a compound weave where a supplementary warp or filling yarn is inlaid into a base fabric to produce an embroidered appearance. (The supplementary or filling yarn is a yarn that can be removed without affecting the base fabric.) Brocade weaves can be continuous where the supplementary yarn floats on the back of the base fabric and is not visible on the fabric face, or discontinuous where the supplementary yarn is woven into the patterned areas visible on the fabric face.
b) Brocatelle—A brocatelle weave is a highly textured or high-relief motif produced with an additional yarn the runs between the fabric face and back to produce a pronounced texture, or dimensionality, or relief to the fabric surface. Brocatelle weaves are typically based on, but not limited to, satin weaves.
c) Camocas—A comocas fabric is typically a stain weave with a diapered design.
d) Crepe-back satin, Satin-back crepe, Crepe-satin, or Satin-crepe—These fabrics typically comprise a stain weave on the fabric face and a crepe crinkled affect produced by the weave, yarn or finishing technique on the back of the fabric. Typically weft crepe yarns are twisted and outnumber any supplemental or filling yarn by a factor of at least 2:1.
e) Duchesse—A duchesse weave is a high thread count satin weave, typically woven with fine yarns having a higher density of warp to weft yarns. Duchesse fabrics have a high luster and are highly textured and firm.
f) Satin—A warped-faced satin weave satin weave is a weave where warp yarns pass over multiple weft yarns before interlacing another waft yarn, or filling-faced satin weave where weft yarns pass over multiple warp yarns before interlacing another warp yarn. A satin weave produces a fabric surface where the warp and weft intersection points are as widely spaced as possible. Satins are typically woven with low twist filament yarns.
g) Double-face satin—A double-face satin has two satin constructions, one on the face and another on the back, produced by a weave having two warps and one weft.
h) Paillette satin—A paillette stain is a weave that produces a changeable color affect.
i) Peau de soie—A peau de soie stain weave can be of a single or double construction, typically characterized by a cross-rib texture in the weft direction and a slight luster.
j) Satin-back—A satin-back fabric is characterized by a weave and/or fabric on one side and any other weave or fabric on the opposing fabric side.
k) Satin foaconne—A stain foaconne is a slightly creped fabric with small designs.
l) Slipper satin—A slipper satin is a compact satin that can be brocaded.
m) Velvet satin—A velvet satin comprises a warp-pile satin weave with a short, dense cut pile. The pile consists of a looped yarn on the fabric surface; the loop can be produced by: 1) knotting the yarn at the base of the fabric; 2) weaving the yarn over wires to produce loops at the base of the fabric and cutting the loops to produce a cut pile; or 3) weaving the warp yarn to produce a double cloth and slicing the warp yarns positioned between the two opposing cloth surfaces to produce two cut-pile fabrics.

Moreover, the textile can be a non-woven fabric. However, this configuration is not preferred in most applications.

In step 120, a flock transfer 200 is provided. The flock transfer 200 comprises a plurality of flock fibers 210 having first 270 and second 280 flock fiber ends, a release adhesive 240 and a carrier sheet 220. The release adhesive 240 is positioned between the plurality of flock fibers 210 and the carrier sheet 220. The second flock fiber ends 280 are adhered to the carrier sheet 220 by the release adhesive 230. Suitable carrier sheets 220, release adhesives 240 and flock fibers 210 are discussed in U.S. Pat. Nos. 4,810,549; 5,047,103; 5,207,851; 6,010,764; 6,110,560; 7,344,769; 7,364,782; 6,929,771; 6,977,023; 7,465,672; and 7,393,576 all to Abrams, each of which are incorporated herein by this reference in their entirety.

In a preferred embodiment, the flock transfer 200 has one or more flock transfer registration indexes 225. Preferably, the one or more flock transfer registration indexes 225 are positioned on the carrier sheet 220. The flock transfer registration indexes 225 can be at least one of optical and/or mechanical registration indexes. Non-limiting examples of flock transfer registration indexes 225 are notches, apertures, optically identifiable symbols, and insert identifiable profile characteristics (such as, a physical characteristic of the flock transfer 200 and/or carrier sheet, e.g. height, depth, edge, etc.). In some configurations, the flock transfer registration index 225 can comprise the flock fibers 210, such as, the a characteristic contained with a pattern contained within and/or formed by the plurality of the flock fibers 210. Registration indexes (as applicable to one or both of the insert and flock transfer registration indexes) and methods for use thereof are discussed in U.S. patent application Ser. No. 12/580,120 with a filing date of Oct. 15, 2009, which is incorporated herein by this reference in its entirety.

In one embodiment, step 130 comprises contacting the first insert surface of the insert 230 with a first adhesive 290 prior to contacting the first adhesive 290 with the flock transfer 200. The first adhesive 290 is contacted and positioned on the first insert surface relative to the one or more insert registration indexes 235. The first adhesive 290 is positioned on the first insert surface one or more of before, after and/or during optical and/or mechanical identification of the one or more insert registration indexes 235. Preferably, the first adhesive 290 is contacted with the first insert surface in a printing process. More preferably, the first adhesive 290 is contacted with the insert 230 in a screen-printing process.

In another embodiment, the step 130 comprises contacting the first flock fiber ends 270 with the first adhesive 290 prior to the contacting the first adhesive 290 with the insert 230. The 290 is contacted and positioned on the first fiber ends 270 of the flock fibers 210 relative to the one or more flock fiber registration indexes 225. Preferably, the first adhesive 290 is positioned on the first fiber ends 270 one or more of before, after and during optical and/or mechanical identification of the one or more flock transfer registration indexes 225. Preferably, the first adhesive 290 is contacted with the first fiber ends 270 in a printing process. More preferably, the first adhesive 290 is contacted with the flock transfer 200 in a screen-printing process.

In yet another embodiment, the step 130 comprises contacting the first flock ends 270 and insert 230 substantially simultaneously with the first adhesive 290. The first adhesive 290 is contacted and positioned on the first insert surface of the insert 230 and the first fiber ends 270 relative to the one or more insert 235 and the flock transfer 225 registration indexes. The first adhesive 290 is positioned on the insert 230 and flock fibers 210 after and/or during optical and/or mechanical identification of the one or more insert 235 and flock transfer 225 registration indexes. Preferably, the first adhesive 290 is a self-supporting adhesive film and/or sheet.

Optionally, a second adhesive 250 is positioned on the second insert surface. Preferably, the second adhesive 250 is adhered to the second insert surface. The second adhesive 250 can provided the insert 230 with dimensional stability. The dimensional stability substantially aids in accuracy and precision in the mechanical and/or optical alignment with the one or more insert registration indexes 235. That is, the dimensional stability provided by the second adhesive 250 substantially aids in the accuracy and precision in contacting the first adhesive 290 with the insert first surface relative to the one or more insert registration indexes 235. In another embodiment, the first adhesive comprises a self-supporting adhesive film and/or sheet.

The first adhesive 290 comprises any adhesive or adhesive formulation. Preferably, the first adhesive 290 is one of a thermoplastic adhesive, a thermosetting adhesive and a combination of thermosetting and/or thermoplastic adhesives. More preferably, the first adhesive 290 is a thermoplastic adhesive. In some embodiments, the first adhesive 290 comprises a thermosetting adhesive. Suitable first adhesives 290 are discussed in U.S. Pat. Nos. 4,810,549; 5,047,103; 5,207,851; 6,010,764; 6,110,560; 7,344,769; 7,364,782; 6,929,771; 6,977,023; 7,465,672; and 7,393,576 all to Abrams, each of which are incorporated herein by this reference in their entirety.

In a preferred embodiment, the first adhesive 290 comprises one of polyurethane, a polyester and a combination of polyurethane and polyester adhesives. In another preferred embodiment, the first adhesive 290 comprises a water-based emulsion and/or dispersion of a thermoplastic adhesive. In some configurations, the first adhesive 290 comprises a self-supporting adhesive film and/or sheet.

The optional second adhesive 250 comprises any adhesive or adhesive formulation. Preferably, the second adhesive 250 is one of a thermoplastic adhesive, a thermosetting adhesive and a combination of thermosetting and/or thermoplastic adhesives. More preferably, the second adhesive 250 is a thermoplastic adhesive. In some embodiments, the second adhesive 250 comprises a thermosetting adhesive.

In another preferred embodiment, the second adhesive 250 comprises a water-based emulsion and/or dispersion of a thermoplastic adhesive. In a more preferred embodiment, the second adhesive 250 comprises one of polyurethane, a polyester and a combination of polyurethane and polyester adhesives. In some configurations, the second adhesive 250 comprises a self-supporting adhesive film and/or sheet.

In one embodiment, the second adhesive 250 is a laminate having two or more adhesive layers. When the second adhesive 250 has more than two layers, at least one of the more than two layers can be a composition other than an adhesive composition. In a preferred embodiment, the second adhesive 250 comprises dual laminate adhesive film having first and second adhesive layers. In another preferred embodiment, the second adhesive 250 comprises a tri-layer laminate adhesive film having a third layer positioned between first and second adhesive layers. The first adhesive layer is positioned on the second insert surface. The first adhesive layer is formulated for bonding to the insert (such as, a woven textile insert). The second adhesive layer is formulated for bonding to a substrate, such as, an apparel item (shirt, jacket, pants, trousers, shoes, jersey, athletic equipment, and athletic apparel) and other commercial items (such as, automotive equipment, electronic equipment, and house hold items). The third layer can comprise an elastomeric film. The first and second adhesive layers can have elastomeric properties. The first and second adhesive layers can have the same composition or can have differing compositions.

The first 290 and second 250 adhesives can substantially have the same composition or can have differing compositions. Preferably, the first 290 and second 250 adhesives have elastomeric properties. In a preferred embodiment, one or both of the first 290 and second 250 adhesives substantially lack an environmental contaminant. In a more preferred embodiment, at least one of the first 290 and second 250 adhesives are substantially free of one or more of formaldehyde, epichlorohydrin, and volatile organic compounds.

In step 140, the flock assembly 180 is formed by adhering the first flock fiber ends 270 to the insert 230. The first adhesive 290 permanently adheres the flock fibers 210 to the insert 230. Step 140 further comprises one of: a) contacting the flock transfer 200 with the first adhesive 290, after the first adhesive 290 has been contacted the insert 230; b) the first adhesive 290 is contacted with the flock transfer 200 before the first adhesive 290 is contacted with the insert 230; and c) the first adhesive 290 is contacted substantially simultaneously with the insert 230 and the flock transfer 200.

In a preferred embodiment, the flock transfer 200 is contacted and positioned on the insert 230 relative to the one or both of the one or more woven textile indexes 235 and the one or more flock transfer registration indexes 225. In a more preferred embodiment, one of before, after and/or during the contacting one or both of heat and pressure are applied to at least one of the flock transfer 200 and insert 230 to adhere the flock transfer 200 to the insert 230. In one embodiment, one or both of the heat and pressure is applied to one or more of the insert 230, first adhesive 290 and flock transfer 200. In configuration, the pressure is at least sufficient to embed the first fiber ends 270 substantially into the first adhesive 290. In yet another configuration, the amount of heat applied is at least sufficient to soften the first adhesive 270 so that the first fiber ends 270 can be embedded into the first adhesive 290. When the first adhesive 270 is a thermosetting adhesive, the amount of heat applied in some embodiments is sufficient to at least substantially B- and/or C-stage the thermosetting first adhesive 270. Suitable values for the heat and/or pressure applied are disclosed in the following U.S. Pat. Nos. 4,810,549; 5,047,103; 5,207,851; 6,010,764; 6,110,560; 7,344,769; 7,364,782; 6,929,771; 6,977,023; 7,465,672; and 7,393,576, each of which is incorporated herein in its entirety by this reference.

In step 160, cutting flocked assembly 180 forms flocked appliqué 300. In step 160, the flocked appliqué 300 having a desired shape and/or size is formed from the flocked assembly 180 by cutting the flocked assembly 180. The cutting process can be a mechanical process. Non-limiting examples of mechanical trimming are cutting with shears, a knife, a die, and/or an air-knife. Other non-limiting examples of trimming process step 200 are cutting with electric arcs, hot-wires, laser beams, plasma arcs, and other high-energy beams and/or devices. Preferably, the cutting comprises one cutting with a laser, a hot wire, and an electric arc. Cutting with a laser, electric arcs and hot wire are preferred for their ability to seal the edges 310 of the flocked appliqué 300. For example, laser and/or hot wire cutting substantially seals the edges 310 of the insert 180. Preferably, the sealing of the edges 310 substantially eliminates one or more of fraying and/or unraveling of the woven insert edge.

In another embodiment, the insert 230 has a surface 260 covered in part by the flock fibers 210 of flock transfer 200. That is, the flocked assembly 280 has at least one void 190. The surface 260 above void 190 is free of flock fibers 210. In another embodiment, the flock fibers 210 surround the void 190. In yet another embodiment, the void 260 surrounds the flock fibers 210. In yet another embodiment, the void 260 surrounds and is surrounded by the flock fibers 210.

In another aspect, the carrier sheet 220 and release adhesive 240 are removed from the flocked appliqué 300 to form a flocked product (not shown). In another configuration, the carrier sheet 220 and release adhesive 240 are removed from the flocked assembly 180 to form another flocked product (not shown).

In yet another aspect of the present invention, the step 120 (the providing flock transfer step) is replaced with a direct flocking step. The direct flocking can be, but is not limited to, one of an electrostatic flocking step, a flock screen printing step, an spraying flocking step, or any other direct flocking process well known within the art.

A number of variations and modifications of the invention can be used. It would be possible to provide for some features of the invention without providing others.

The present invention, in various embodiments, configurations, or aspects, includes components, methods, processes, systems and/or apparatus substantially as depicted and described herein, including various embodiments, configurations, aspects, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A process, comprising: after contacting a first adhesive with an insert, contacting a flock transfer with the first adhesive to form a flocked assembly.

2. The process of claim 1, wherein the insert comprises a woven textile having opposing first and second woven textile sides and wherein the first woven side is contacted with the first adhesive.

3. The process of claim 2, wherein a second adhesive is in contact with the second woven textile side.

4. The process of claim 2, wherein the woven textile comprises flat, smooth weave and wherein the weave comprises a high luster yarn and/or fiber.

5. The process of claim 2, wherein the woven textile comprises one of:
i) a satin weave;
ii) a satin weave having an interlacing float of at least 2;
iii) a brocade weave;
iv) a brocatelle weave;
v) a camocas weave;
vi) a crepe weave;
vii) a duchesse weave;
viii) a double-face satin weave;
ix) a paillette satin weave;
x) a peaue de soie weave;
xi) a satin-back weave;
xii) a satin foaconne weave;
xiii) a slipper satin weave;
xiv) a velvet satin weave; and
xv) a non-satin weave, having a degree of dimensionality and/or character.

6. The process of claim 3, wherein the first adhesive comprises one of a thermoplastic adhesive, a thermosetting adhesive and a combination of thermosetting and/or thermoplastic adhesives, wherein the second adhesive comprises one of a thermoplastic adhesive, a thermosetting adhesive and a combination of thermosetting and/or thermoplastic adhesives and wherein the first and second adhesives can differ in composition.

7. The process of claim 6, wherein the second adhesive comprises an adhesive laminate having two or more layers.

8. The process of claim 7, wherein one or both of the first and second adhesives have at least one elastomeric property.

9. The process of claim 3, wherein one or both of the first and second adhesives are substantially free of one or more of formaldehyde, epichlorohydrin, a volatile organic compound.

10. The process of claim 1, wherein the contacting of the first adhesive with the insert is by a printing process.

11. The process of claim 10, wherein the printing process is a screen printing process.

12. The process of claim 1, wherein the insert has one or more insert registration indexes.

13. The process of claim 12, wherein the first adhesive is contacted and positioned on the insert relative to the one or more insert registration indexes.

14. The process of claim 1, wherein the flock transfer comprises a plurality of flock fibers having opposing first and second flock fiber ends, a release adhesive and a release sheet, the release adhesive is positioned between the release sheet and the plurality of flock fibers, wherein the first flock fiber ends are adhered to the release sheet by the release adhesive and wherein the second flock fiber ends are adhered directly to the insert by the first adhesive.

15. The process of claim 14, further comprising, applying one or both of heat and pressure to flocked assembly to adhere the flock transfer to the insert, wherein the flock transfer has one or more flock transfer registration indexes.

16. The process of claim 14, wherein the flock transfer is contacted and positioned on the insert relative to the one or both of the one or more insert indexes and the one or more flock transfer registration indexes.

17. The process of claim 1, further comprising:
cutting the flocked assembly to form a flocked appliqué.

18. The process of claim 17, wherein the cutting is by one of a laser, a hot wire, and an electric arc.

19. A process, comprising:
(a) positioning a first adhesive on an insert relative to one or more insert registration indexes;
(b) providing a flock transfer having:
one or more flock transfer registration indexes; and
free flock fiber ends;
(c) registering the one or more flock registration indexes with the one or more insert indexes and contacting the free flock fiber ends with the first adhesive to form a flocked assembly;
(d) applying one or both of heat and pressure to the flocked assembly to adhere the free flock fiber ends of the flock transfer directly to the insert; and
(e) cutting the flocked assembly to form a flocked appliqué.

20. The process of claim 19, wherein the insert comprises a woven textile containing one or both of a dye-printed image and an image woven into the woven textile, wherein the woven textile has opposing first and second woven textile sides, wherein the first adhesive is position the first woven textile side, wherein a second adhesive is positioned on the second woven textile side, wherein the second adhesive comprises one of a thermoplastic adhesive, a thermosetting adhesive and a combination of thermosetting and/or thermoplastic adhesives.

21. The process of claim 20, wherein the woven textile comprises a high luster yarn and/or fiber and wherein the woven textile comprises one flat, smooth weave or a highly textured, dimensionalized, loose, open weave with a high weave loft.

22. The process of claim 19, wherein the first adhesive comprises one of a thermoplastic adhesive, a thermosetting adhesive and a combination of thermosetting and/or thermoplastic adhesives.

23. The process of claim 19, wherein the contacting a first adhesive with the insert is by a printing process.

24. The process of claim 23, wherein the printing process is a screen printing process.

25. The process of claim 19, wherein the flock transfer comprises a plurality of flock fibers adhered to a release sheet by a release adhesive and wherein the release adhesive is positioned between the release sheet and the plurality of flock fibers.

26. The process of claim 19, wherein the cutting is by one of a laser, a hot wire, and an electric arc.

27. The process of claim 19, wherein the insert has opposing first and second insert surfaces, wherein the first adhesive is positioned on the first insert surface and a second adhesive is positioned on the second insert surface and the second adhesive comprises one of a thermoplastic adhesive, a thermosetting adhesive and a combination of thermosetting and/or thermoplastic adhesives.

28. The process of claim 27, wherein the second adhesive comprises an adhesive laminate having two or more layers and wherein at least one of the adhesive layers has at least one chemical and/or physical property differing from the other adhesive layers.

29. The process of claim 27, wherein one or both of the first and second adhesives have at least one elastomeric property.

30. The process of claim 27, wherein one or both of the first and second adhesives are substantially free of one or more of formaldehyde, epichlorohydrin, and a volatile organic compound.

31. A process, comprising:
(a) providing a flock transfer having:
one or more flock transfer registration indexes; and
free flock fiber ends;
(b) positioning a first adhesive on the free flock fiber ends relative to the one or more flock transfer registration indexes;
(c) providing an insert having one or more insert registration indexes;
(d) registering the one or more flock registration indexes with the one or more insert indexes and contacting the insert with the first adhesive to form a flocked assembly;
(e) applying one or both of heat and pressure to the flocked assembly to adhere the flock transfer to the insert; and
(f) cutting the flocked assembly to form a flocked appliqué.

32. An article, comprising:
flock fibers having opposing first and second flock fiber ends, the first flock fiber ends are directly adhered to a first adhesive and the second flock fiber ends are adhered to a carrier sheet by a release adhesive, wherein one or both of the carrier sheet and the flock fibers have one or more flock transfer registration indexes; and
an insert having one or more insert registration indexes, wherein the insert is directly adhered to the first flock fiber ends by the first adhesive.
